(19) United States
(12) Patent Application Publication
(10) Pub. No.: US 2018/0143492 A1
(43) Pub. Date: May 24, 2018

(54) DISPLAY DEVICE

(71) Applicant: Innolux Corporation, Miao-Li County (TW)

(72) Inventors: Chen-Kuan Kao, Miao-Li County (TW); Yu-Ju Chen, Miao-Li County (TW); Chun-Teng Chen, Miao-Li County (TW)

(21) Appl. No.: 15/813,273

(22) Filed: Nov. 15, 2017

(30) Foreign Application Priority Data
Nov. 21, 2016 (CN) 201611024645.4

(51) Int. Cl. G02F 1/1335; G02F 1/1337

(52) U.S. Cl. CPC G02F 1/133602; G02F 1/133528; G02F 1/1337

(57) ABSTRACT

A display device including a first substrate, a second substrate, a display medium, a color converting layer and a backlight module is provided. The display medium is disposed between the first substrate and the second substrate, and includes blue phase liquid crystal (BP-LC), polymer dispersed liquid crystal (PD-LC), self-assembled liquid crystal (SA-LC), dye doped nematic liquid crystal, dye doped cholesteric liquid crystal, dye doped blue phase liquid crystal, dye doped polymer dispersed liquid crystal or dye doped self-assembled liquid crystal. The color converting layer is disposed on the second substrate, and includes multiple quantum dots. The first substrate is disposed between the backlight module and the display medium.

This application claims the benefit of People's Republic of China application Serial No. 201611024645.4, filed Nov. 21, 2016, the subject matter of which is incorporated herein by reference.

### BACKGROUND OF THE INVENTION

### Field of the Invention

The disclosure relates in general to a display device, and more particularly to a liquid crystal display device.

### Description of the Related Art

In response to people's pursuit of high brightness and high color of the visual screen, the technology of color display is developed and used. The display is used in many fields of people's daily life such as advertising billboard, TV, and car navigation. However, the development of various types of display screens including the cathode ray tube (CRT) screen to the plasma screen, the liquid crystal screen, and the organic light emitting diode (OLED) screens all encounter similar problems.

Therefore, how to provide a display panel having excellent display quality and technology competitiveness has become a prominent task for the industries.

### SUMMARY OF THE INVENTION

The present disclosure is directed to a display device. According to the display device of an embodiment of the present disclosure, a blue light emitted from a backlight module excites the quantum dots in each color region of the color converting layer to generate a light. The color converting layer doped with quantum dots is a self-luminous color converting layer of which the luminous efficiency at least is above 70-90%, and therefore the overall luminous efficiency of the display device is increased.

According to one embodiment of the present disclosure, a display device is provided. The display device includes a first substrate, a second substrate, a display medium, a color converting layer and a backlight module. The display medium is disposed between the first substrate and the second substrate, and includes blue phase liquid crystal (BP-LC), polymer dispersed liquid crystal (PD-LC), self-assembled liquid crystal (SA-LC), dye doped nematic liquid crystal, dye doped cholesteric liquid crystal, dye doped blue phase liquid crystal, dye dispersed liquid crystal or dye doped self-assembled liquid crystal. The color converting layer is disposed between the display medium and the second substrate, and includes multiple quantum dots. The first substrate is disposed between the backlight module and the display medium.

According to another embodiment of the present disclosure, a display device is provided. The display device includes a first substrate, a second substrate, a display medium, a color converting layer, a backlight module, a first polarizer, a second polarizer and a backlight module. The display medium is disposed between the first substrate and the second substrate, and includes dye doped liquid crystal. The color converting layer is disposed between the display medium and the second substrate, and includes multiple quantum dots. The first substrate is disposed between the backlight module and the display medium. The first polarizer is disposed between the first substrate and the backlight module. The first alignment layer is disposed between the first substrate and the display medium.

According to a further embodiment of the present disclosure, a display device is provided. The display device includes a first substrate, a second substrate, a display medium, a color converting layer, a first polarizer, a second polarizer and a backlight module. The display medium is disposed between the first substrate and the second substrate, and the display medium includes optically isotropic liquid crystal. The first polarizer is disposed between the first substrate and the backlight module. The second polarizer is disposed between the second substrate and the display medium. The first polarizer is disposed between the first substrate and the backlight module.

### BRIEF DESCRIPTION OF THE DRAWINGS

The above and other aspects of the disclosure will become better understood with regard to the following detailed description of the preferred but non-limiting embodiment(s). The following description is made with reference to the accompanying drawings.

FIG. 1 is a schematic diagram of a display device according to an embodiment of the present disclosure.

FIG. 2 is a schematic diagram of a display device according to another embodiment of the present disclosure.

FIG. 3A is a cross-sectional view of a display device according to another embodiment of the present disclosure.

FIGS. 3B-3D are schematic diagrams of display devices according to some other embodiments of the present disclosure.

FIG. 4 is a cross-sectional view of a display device according to another embodiment of the present disclosure.

FIG. 5 is a cross-sectional view of a display device according to another embodiment of the present disclosure.

FIG. 6 is a cross-sectional view of a display device according to another embodiment of the present disclosure.

### DETAILED DESCRIPTION OF THE INVENTION

According to the display device of an embodiment of the present disclosure, a blue light emitted from a backlight module excites the quantum dots in each color region of the color converting layer to generate a light. The color converting layer doped with quantum dots is a self-luminous color converting layer of which the luminous efficiency at least is above 70-90%, and therefore the overall luminous efficiency of the display device is increased. Detailed descriptions of the embodiments of the present disclosure are made with reference to accompanying drawings. Designations common to the accompanying drawings and embodiments are used to indicate identical or similar elements. It should be noted that the accompanying drawings are simplified such that the embodiments can be more clearly described. Technical structures disclosed in the embodiments are for explanatory and exemplary purposes only, not for limiting the scope of protection of the present disclosure. Any person ordinary skilled in the technology of the present disclosure can make suitable modifications or variations to the structures according to the needs in actual implementations.

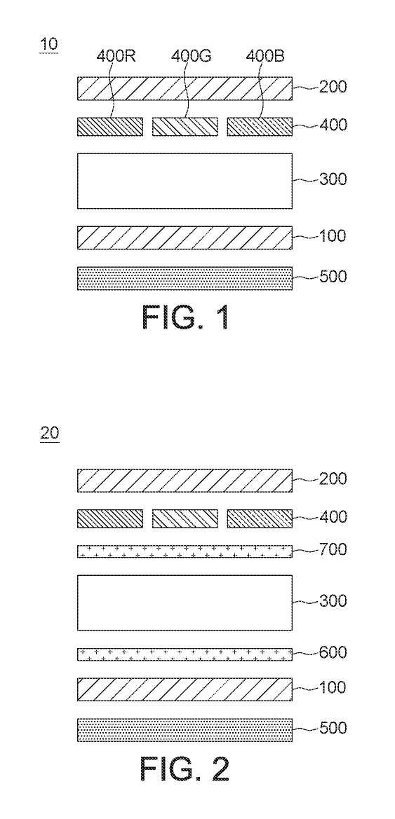

FIG. 1 is a schematic diagram of a display device according to an embodiment of the present disclosure. As indicated in FIG. 1, the display device 10 includes a first substrate 100, a second substrate 200, a display medium 300, a color converting layer 400 and a backlight module 500. The display medium 300 is disposed between the first substrate 100 and the second substrate 200. The color converting layer 400 is disposed between the display medium 300 and the second substrate 200, and the color converting layer 400 includes multiple quantum dots. The first substrate 100 is disposed between the backlight module 500 and the display medium 300.

In some embodiments, the display medium 300 includes blue phase liquid crystal (BP-LC), polymer dispersed liquid crystal (PD-LC), self-assembled liquid crystal (SA-LC), dye doped nematic liquid crystal, dye doped cholesteric liquid crystal, dye doped blue phase liquid crystal, dye doped polymer dispersed liquid crystal or dye doped self-assembled liquid crystal, and the display medium 300 may be formed of any one of the above or any combination thereof. Any liquid crystals conformed with the characteristics may be used as the display medium, but the present disclosure is not limited thereto. In some embodiments, the backlight module 500 may be a blue backlight module.

In an embodiment, the color converting layer 400 may include a red region 400R, a green region 400G and a blue region 400B. In an embodiment of the present disclosure, the color converting layer 400 is doped with quantum dots. Therefore, with the design of the quantum dots, a blue light emitted from the backlight module 500 excites the quantum dots in each color region of the color converting layer 400 to generate a light. That is, the color converting layer 400 doped with quantum dots is a self-luminous color converting layer. In some embodiments, since the backlight module 500 emits the blue light, the blue region 400B may be formed of a transparent material or may be disposed without any filers. The transparent material may be an insulation layer, such as silicon nitride (SiNx) or silicon oxide (SiOx). Or, the blue region 400B may be formed of a highly light-transmitting organic glue such as acrylic glue or epoxy glue, but the present disclosure is not limited thereto. Moreover, the blue region 400B not doped with quantum dots can also be used.

In comparison to a conventional display device, which adopts a white light backlight source, when the white light passes through an RGB color filter, the light of undesired colors is absorbed by the color filter, only the light of predetermined colors can pass through the RGB color filter and illuminate, and thus a penetration rate of only about 33% is achieved. In contrast, according to the embodiments of the present disclosure, the display device uses the blue light emitted from the backlight module 500 to excite the quantum dots in each color region of the color converting layer 400 to generate a light, and thus a luminous efficiency at least above 70-90% can be achieved, such that the overall luminous efficiency of the display device can be increased.

In some embodiments as indicated in FIG. 1, when the display medium 300 is formed of dye doped blue phase liquid crystal, dye doped polymer dispersed liquid crystal or dye doped self-assembled liquid crystal, the display device 10 may not include any polarizer or any alignment layer.

Dye doped in liquid crystal can absorb lights, and the arrangement of dye molecules can be changed by applying a voltage. When the dye molecules are arranged in a direction perpendicular to the incident direction of the light (that is, the dye molecules basically lay flat along a direction parallel to the substrate surface), the light passing through the liquid crystal is absorbed by the surrounding dye molecules and a dark state will be formed. When the dye molecules are arranged in a direction parallel to the incident direction of the light (that is, the dye molecules basically stand along a direction perpendicular to the substrate surface), the light can pass through the dye molecules standing vertically, and a bright state is formed. The dye molecules are dichroic dye and can be dispersed in the liquid crystal, and the dye molecules rotate when the liquid crystal rotates. Based on the above reasons, the display device 10 of FIG. 1 may not include a polarizer, and thus has the advantage that 50% of the incident light is not absorbed by a polarizer. In other words, the display device 10 increases the penetration rate of the light and therefore increases the luminous efficiency.

Furthermore, since the quantum dots possess the function of depolarization, the color converting layer 400 doped with quantum dots must be disposed outside the polarizer, and thus the polarizer must be an in-cell polarizer of which the manufacturing process is relatively complicated. Therefore, the manufacturing process of the color converting layer 400 doped with quantum dots can be simplified when the manufacturing process of a polarizer is omitted.

Besides, blue phase liquid crystal, polymer dispersed liquid crystal and self-assembled liquid crystal all can be aligned without needing an alignment layer. Since the process temperature of the color converting layer 400 doped with quantum dots is about 120-130° C., and the alignment layer normally has a higher process temperature (such as 220-230° C.); when the manufacturing process of an alignment layer is omitted, the manufacturing process of the color converting layer 400 doped with quantum dots can be simplified, and the color converting layer 400 doped with quantum dots can be less affected by thermal processes.

FIG. 2 is a schematic diagram of a display device according to another embodiment of the present disclosure. Designations common to the present and previous embodiments are used to indicate identical or similar elements. Relevant descriptions of identical or similar elements can be obtained with reference to above disclosure, and are not repeated here.

As indicated in FIG. 2, the display device 20 may further include a first alignment layer 600 and a second alignment layer 700. The first alignment layer 600 is disposed between the first substrate 100 and the display medium 300. The second alignment layer 700 is disposed between the second substrate 500 and the display medium 300. In some embodiments, the first alignment layer 600 and the second alignment layer 700 are respectively disposed on two opposite sides of the display medium 300.

In some embodiments as indicated in FIG. 2, when the display medium 300 is formed of dye doped nematic liquid crystal or dye doped cholesteric liquid crystal, the display device 20 may not include a polarizer.

In comparison to the display device 10 of previous embodiment, the display device 20 of the embodiment as indicated in FIG. 2 additionally includes two alignment layers, yet the display device 20 may not include a polarizer as well, and therefore the penetration rate of the light still can be increased. In the present embodiment, the bright state or the dark state can be adjusted by changing the arrangement of the dye molecules through the way of applying a voltage and selecting the type of the first alignment layer 600 and the second alignment layer 700 (both the horizontal alignment and the vertical alignment may be used in the present embodiment).

As disclosed above, the display device 20 of the present embodiment may not include a polarizer but still includes two alignment layers, and therefore has a wider range of selection in terms of liquid crystals. Basically, all dye doped liquid crystals may be used in the present embodiment.

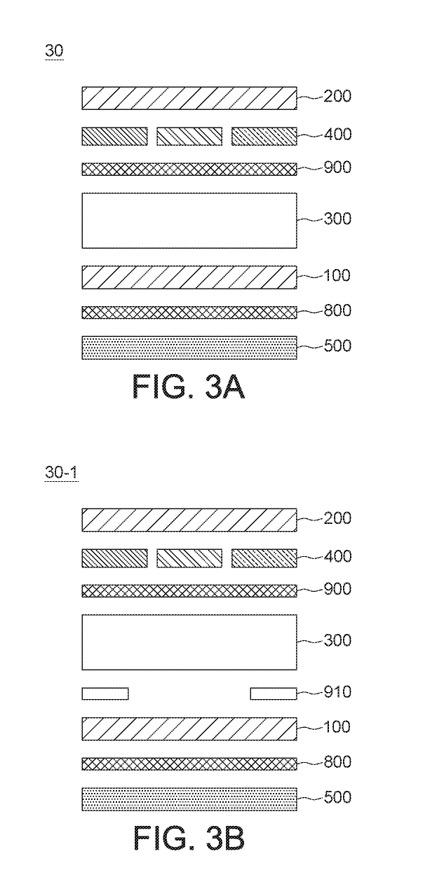

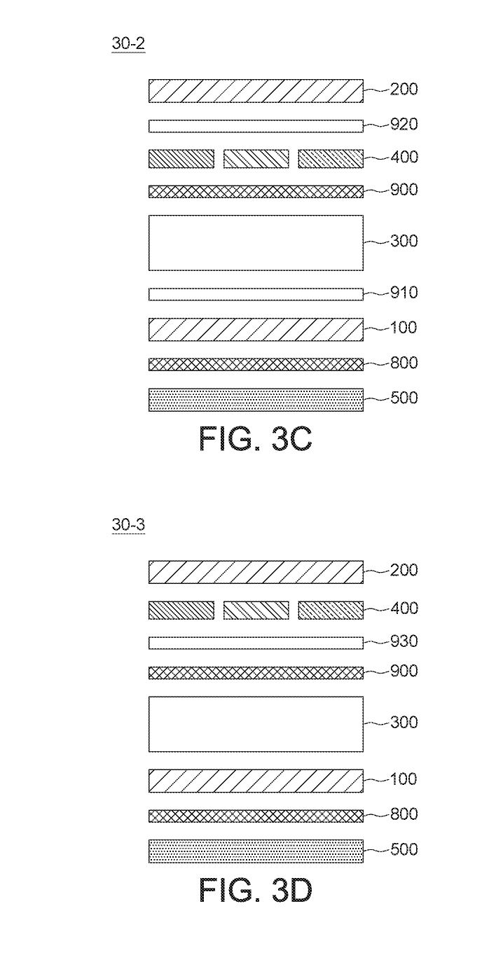

FIG. 3A is a cross-sectional view of a display device according to another embodiment of the present disclosure. Designations common to the present and previous embodiments are used to indicate identical or similar elements.

As indicated in FIG. 3A, the display device 30 may further include a first polarizer 800 and a second polarizer 900. The first polarizer 800 is disposed between the first substrate 100 and the backlight module 500. The second polarizer 900 is disposed between the second substrate 200 and the display medium 300. In some embodiments, the first polarizer 800 and the second polarizer 900 are respectively disposed on two opposite sides of the display medium 300.

In some embodiments as indicated in FIG. 3A, when the display medium 300 is formed of blue phase liquid crystal, polymer dispersed liquid crystal or self-assembled liquid crystal, the display device 30 may not include any alignment layer.

In comparison to the display device 10 of previous embodiment, the display device 30 of the embodiment as indicated in FIG. 3A additionally includes two polarizers, yet the display device 30 may not include any alignment layer. Therefore, a liquid crystal material providing alignment effects as aforementioned needs to be used, such that the effects of preventing the color converting layer 400 doped with quantum dots from being affected by thermal processes can be achieved. Furthermore, the disposition of the polarizers can increase the contrast ratio of the display effect.

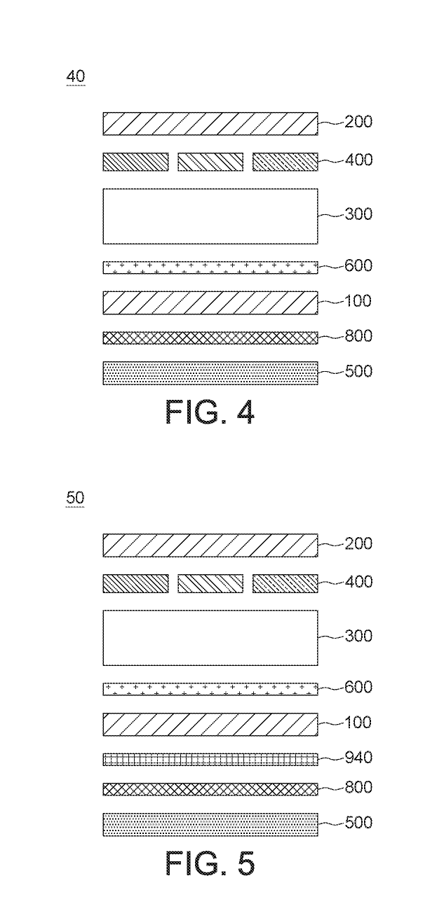

FIGS. 3B-3D are schematic diagrams of display devices according to some other embodiments of the present disclosure. Designations common to the present and previous embodiments are used to indicate identical or similar elements. Relevant descriptions of identical or similar elements can be obtained with reference to above disclosure, and are not repeated here. It should be noted that the display devices of FIGS. 3B-3D are exemplified and explained using the structure of the display device of FIG. 3A, and the elements of the display devices of FIGS. 3B-3D may also be used in other suitable embodiments of the present disclosure, such as the display devices of FIGS. 1-3A or the display devices of FIGS. 4˜6.

In an embodiment as indicated in FIG. 3B, the display device 30-1 may further include a first electrode 910 disposed on the first substrate 100.

In an embodiment as indicated in FIG. 3B, when the display device 30-1 includes a first electrode 910 disposed on only one side of the display medium 300, a horizontal electrical field is generated when a voltage is applied to the first electrode 910. When the liquid crystal material of the display medium 300 is operated in an in-plane switch (IPS) mode, the first electrode 910 is operated under two different voltages for generating a horizontal electrical field. When the liquid crystal material of the display medium 300 is operated in a fringe-field switch (FFS) mode, an added electrode (not illustrated in the diagram) is further disposed between the first electrode 910 and the first substrate 100, and the first electrode 910 and the added electrode are operated under different voltages for generating a fringe electrical field. For example, the self-assembled liquid crystal may be used in conjunction with the fringe electrical field or the horizontal electrical field; thus, when the display medium 300 is formed of self-assembled liquid crystal, the design of the first electrode 910 generating a horizontal electrical field may be adopted. However, self-assembled liquid crystal is for exemplification purpose only, not for limiting the present embodiment the present embodiment.

In an embodiment as indicated in FIG. 3C, the display device 30-2 may further include a first electrode 910 and a second electrode 920, the first electrode 910 is disposed on the first substrate 100, and the second electrode 920 is disposed on the second substrate 200.

In an embodiment as indicated in FIG. 3C, the display device 30-2 includes the first electrode 910 and the second electrode 920 respectively disposed on two opposite sides of the display medium 300. When a voltage is applied, a vertical electrical field is generated. When the liquid crystal material of the display medium 300 is suitable for generating a vertical electrical field, the disposition of the first electrode 910 and the second electrode 920 as illustrated in the present embodiment may be used, and the second electrode 920 may be designed as any suitable patterned electrode when the second electrode 920 is a pixel electrode. For example, blue phase liquid crystal and polymer dispersed liquid crystal must be used in conjunction with the vertical electrical field; thus, when the display medium 300 is formed of blue phase liquid crystal or polymer dispersed liquid crystal, the design of the first electrode 910 and the second electrode 920 generating a vertical electrical field may be adopted. However, blue phase liquid crystal and polymer dispersed liquid crystal are for exemplification purpose only, not for limiting the present embodiment the present embodiment.

In an embodiment as indicated in FIG. 3D, the display device 30-3 may further include a third substrate 930. In some embodiments, the third substrate 930 may include polyethylene terephthalate (PET), polyamide (PI) or the like, but the present disclosure is not limited thereto. The second polarizer 900 is disposed between the third substrate 930 and the display medium 300. In some embodiments, the second polarizer 900 and the second substrate 200 are disposed on the same side of the display medium 300, and the second polarizer 900 is disposed on the third substrate 930.

Conventionally, a polarizer is attached on the outer substrate of the panel after the manufacture of the liquid crystal display panel is completed. As disclosed above, the color converting layer 400 doped with quantum dots must be disposed outside the polarizer, and the polarizer must be an in-cell polarizer of which the manufacturing process is relatively complicated. For example, the in-cell polarizer may require a coating process, a rubbing alignment process, and etc. An example of a commonly seen in-cell polarizer is such as a wire grid polarizer.

In contrast, in the present embodiment, the second polarizer 900 manufactured by a conventional stretching process may firstly be attached on the third substrate 930, and then the second polarizer 900 together with the third substrate 930 are disposed in the display device 30-3. Thus, the manufacturing process of the polarizer may be separated from the manufacturing process of the color converting layer 400 doped with quantum dots and/or the manufacturing process of the alignment layer, hence avoiding the problem of negative influence caused by thermal processes as disclosed above.

FIG. 4 is a cross-sectional view of a display device according to another embodiment of the present disclosure. Designations common to the present and previous embodiments are used to indicate identical or similar elements. Relevant descriptions of identical or similar elements can be obtained with reference to above disclosure, and are not repeated here.

As indicated in FIG. 4, the display device 40 includes a first substrate 100, a second substrate 200, a display medium 300, a color converting layer 400, a backlight module 500, a first polarizer 800 and a first alignment layer 600. The display medium 300 is disposed between the first substrate 100 and the second substrate 200. The color converting layer 400 is disposed between the display medium 300 and the second substrate 200, and the color converting layer 400 includes multiple quantum dots. The first substrate 100 is disposed between the backlight module 500 and the display medium 300. The first polarizer 800 is disposed between the first substrate 100 and the backlight module 500. The first alignment layer 600 is disposed between the first substrate 100 and the display medium 300.

In some embodiments, the display medium 300 may include dye doped liquid crystal; the first polarizer 800 may be a linear polarizer; and the first alignment layer 600 may be a horizontal alignment layer.

In an embodiment as indicated in FIG. 4, the display device 40 includes a first polarizer 800 and a first alignment layer 600. The first polarizer 800 and the first alignment layer 600 are disposed on only one side of the display medium 300 opposite to the color converting layer 400 doped with quantum dots, hence avoiding the color converting layer 400 doped with quantum dots being negatively affected by thermal processes and simplifying the original complicated manufacturing process of the in-cell polarizer.

In some embodiments as indicated in FIG. 4, when the display medium 300 is formed of polymer stabilized dye doped liquid crystal, dye doped nematic liquid crystal or dye doped cholesteric liquid crystal, the display device 40 may include a polarizer and an alignment layer which are disposed on only one side of the display medium 300.

In the present embodiment, the first alignment layer 600 disposed on only one side can provide a basic alignment effect. In order to have better control of the liquid crystal, the first alignment layer 600 is preferably a horizontal alignment layer, and adopting polymer stabilized liquid crystal can further improve the alignment effect as well.

In the present embodiment, the first polarizer 800 disposed on only one side can polarize the incident light to increase the light absorption efficiency of the dye molecules. When the display medium 300 includes dye doped nematic liquid crystal or dye doped cholesteric liquid crystal, the light absorption effect of the dye molecules can further be increased.

In some embodiments, by adopting the structure as previously shown in such as FIG. 2 into the structure as shown in FIG. 4, the display device 40 may further include a second alignment layer 700 disposed between the display medium 300 and the second substrate 500 (not shown in the present drawing).

In some embodiments, by adopting the structures as previously shown in such as FIGS. 3A-3D into the structure as shown in FIG. 4, the display device 40 may further include a second polarizer 900 disposed between the display medium 300 and the second substrate 200 (not shown in the present drawing).

In some embodiments, by adopting the structure as previously shown in such as FIG. 3D into the structure as shown in FIG. 4, the display device 40 may further include a third substrate 930, the second polarizer 900 and the second substrate 200 are disposed on the same side of the display medium 300, and the second polarizer 900 is disposed on the third substrate 930 (not shown in the present drawing).

FIG. 5 is a cross-sectional view of a display device according to another embodiment of the present disclosure. Designations common to the present and previous embodiments are used to indicate identical or similar elements. Relevant descriptions of identical or similar elements can be obtained with reference to above disclosure, and are not repeated here.

As indicated in FIG. 5, the display device 50 may further include a quarter wavelength phase retardation film 940 disposed between the first polarizer 800 and the first substrate 100.

In some embodiments, the display medium 300 may include dye doped liquid crystal. In some embodiments, the display medium 300 may include cholesteric liquid crystal.

For example, the display medium 300 may be formed of polymer stabilized cholesteric liquid crystal, the first polarizer 800 may be a linear polarizer, and the first alignment layer 600 may be a horizontal alignment layer. In an embodiment, the first polarizer 800, which linearly polarizes the incident light, is disposed in conjunction with a quarter wavelength phase retardation film 940 to circularly polarize the incident light.

In the present embodiment, when the display medium 300 is formed of cholesteric liquid crystal doped with a chiral dopant, a cell gap/chiral pitch (d/p) design may be used, such that when no voltage is applied, the circular polarized light is blocked and a dark state is formed; when a voltage is applied to rearrange the liquid crystal, the circular polarized light can pass through the rearranged liquid crystal to form a bright state.

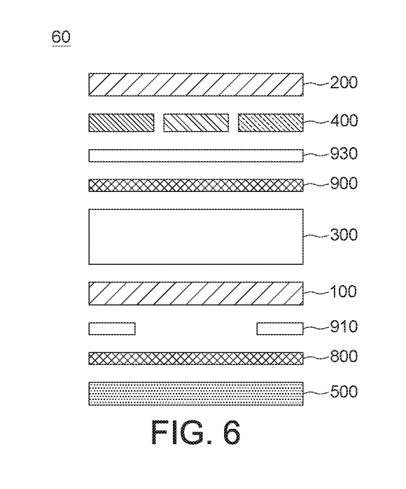

In some embodiments, the display devices 50 and 60 of FIG. 5 and FIG. 6 both may further include a first electrode 910 and/or a second electrode 920 disposed on the first substrate 100 and/or the second substrate 200, respectively.

FIG. 6 is a cross-sectional view of a display device according to another embodiment of the present disclosure. Designations common to the present and previous embodiments are used to indicate identical or similar elements. Relevant descriptions of identical or similar elements can be obtained with reference to above disclosure, and are not repeated here.

As indicated in FIG. 6, the display device 60 includes a first substrate 100, a second substrate 200, a display medium 300, a color converting layer 400, a backlight module 500, a first polarizer 800 and a second polarizer 900. The display medium 300 is disposed between the first substrate 100 and the second substrate 200. The color converting layer 400 is disposed between the first substrate 100 and the second substrate 200, and the color converting layer 400 includes multiple quantum dots. The first polarizer 800 is disposed between the first substrate 100 and the backlight module 500. The second polarizer 900 is disposed between the second substrate 200 and the display medium 300. In some embodiments, the first polarizer 800 and the second polarizer 900 are respectively disposed on two opposite sides of the display medium 300. The first polarizer 800 is disposed between the first substrate 100 and the backlight module 500.

In an embodiment, the display medium 300 of FIG. 6 may include optically isotropic liquid crystal. Therefore, the display device 60 may not include any alignment layer.

In an embodiment as indicated in FIG. 6, the display device 60 may further include a third substrate 930. The second polarizer 900 and the second substrate 200 are disposed on the same side of the display medium 300, and the second polarizer 900 is disposed on the third substrate 930.

In an embodiment as indicated in FIG. 6, the display device 60 may further include a first electrode 910 disposed on the first substrate 100.

In the present embodiment, when the display device 60 includes a first electrode 910 disposed on only one side of the display medium 300, a horizontal electrical field is generated when a voltage is applied to the first electrode 910. When the liquid crystal material of the display medium 300 is operated in an in-plane switch (IPS) mode, the first electrode 910 is operated under two different voltages for generating a horizontal electrical field. When the liquid crystal material of the display medium 300 is operated in a fringe-field switch (FFS) mode, an added electrode (not illustrated in the diagram) is further disposed between the first electrode 910 and the first substrate 100, and the first electrode 910 and the added electrode are operated under different voltages for generating a fringe electrical field. For example, self-assembled liquid crystal may be used in conjunction with the fringe electrical field or the horizontal electrical field; thus, when the display medium 300 is formed of self-assembled liquid crystal, the design of the first electrode 910 generating a horizontal electrical field may be adopted. However, self-assembled liquid crystal is for exemplification purpose only, not for limiting. The absorption axis of the first polarizer 800 and the absorption axis of the second polarizer 900 are perpendicular to each other. When a voltage is applied, the arrangement direction of the liquid crystal will be fixed along the direction of the horizontal electrical field, and a bright state will be formed. When no voltage is applied and no electrical field is generated, the arrangement of the liquid crystal is random, and a dark state will be generated if the absorption axis of the first polarizer 800 and the absorption axis of the second polarizer 900 are perpendicular to each other.

While the disclosure has been described by way of example and in terms of the preferred embodiment (s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display device, comprising:
a first substrate and a second substrate;
a display medium disposed between the first substrate and the second substrate, wherein the display medium comprises blue phase liquid crystal, polymer dispersed liquid crystal, self-assembled liquid crystal, dye doped nematic liquid crystal, dye doped cholesteric liquid crystal, dye doped blue phase liquid crystal, dye doped polymer dispersed liquid crystal or dye doped self-assembled liquid crystal;
a color converting layer disposed between the display medium and the second substrate, wherein the color converting layer comprises a plurality of quantum dots; and
a backlight module, wherein the first substrate is disposed between the backlight module and the display medium.

2. The display device according to claim 1, wherein the color converting layer comprises a red region, a green region and a blue region.

3. The display device according to claim 1, further comprising:
a first alignment layer disposed between the first substrate and the display medium; and
a second alignment layer disposed between the second substrate and the display medium.

4. The display device according to claim 1, further comprising:
a first polarizer disposed between the first substrate and the backlight module; and
a second polarizer disposed between the second substrate and the display medium.

5. The display device according to claim 4, further comprising:
a third substrate, wherein the second polarizer is disposed between the third substrate and the display medium.

6. A display device, comprising:
a first substrate and a second substrate;
a display medium disposed between the first substrate and the second substrate, wherein the display medium comprises dye doped liquid crystal;
a color converting layer disposed between the display medium and the second substrate, wherein the color converting layer comprises a plurality of quantum dots;
a backlight module, wherein the first substrate is disposed between the backlight module and the display medium;
a first polarizer disposed between the first substrate and the backlight module; and
a first alignment layer disposed between the first substrate and the display medium.

7. The display device according to claim 6, wherein the display medium is polymer stabilized dye doped liquid crystal, and the first polarizer is a linear polarizer.

8. The display device according to claim 6, further comprising:
a quarter wavelength phase retardation film disposed between the first polarizer and the first substrate, wherein the display medium is cholesteric liquid crystal, and the first polarizer is a linear polarizer.

9. The display device according to claim 6, wherein the color converting layer comprises a red region, a green region and a blue region.

10. The display device according to claim 6, further comprising:
a second alignment layer disposed between the display medium and the second substrate.

11. The display device according to claim 6, further comprising:
a second polarizer disposed between the display medium and the second substrate.

12. The display device according to claim 11, further comprising:
a third substrate, wherein the second polarizer and the second substrate are disposed on the same side of the display medium, and the second polarizer is disposed on the third substrate.

13. A display device, comprising:
a first substrate and a second substrate;
a display medium disposed between the first substrate and the second substrate, wherein the display medium comprises optically isotropic liquid crystal;
a color converting layer disposed between the first substrate and the second substrate, wherein the color converting layer comprises a plurality of quantum dots;
a first polarizer disposed between the first substrate and the backlight module;
a second polarizer disposed between the second substrate and the display medium; and
a backlight module, wherein the first polarizer is disposed between the first substrate and the backlight module.

14. The display device according to claim 13, wherein the color converting layer comprises a red region, a green region and a blue region.

15. The display device according to claim 13, further comprising:
a third substrate, wherein the second polarizer and the second substrate are disposed on the same side of the display medium, and the second polarizer is disposed on the third substrate.
